(19) United States
(12) Patent Application Publication
(10) Pub. No.: US 2025/0263586 A1
(43) Pub. Date: Aug. 21, 2025

(54) Detachably bonded foam products

(71) Applicant: Alfa-Klebstoffe AG, Rafz (CH)

(72) Inventors: Thomas SIMMLER, Hüntwangen (CH); Julian HEUSSER, Dussnang (CH); Marcel GFELLER, Rümlang (CH)

(21) Appl. No.: 18/582,606

(22) Filed: Feb. 20, 2024

(51) Int. Cl. C09J 5/00; B32B 5/18; B32B 5/32; B32B 7/12; B32B 37/10; B32B 37/12; C09J 11/06; C09J 133/08; C09J 175/04

(52) U.S. Cl. CPC C09J 5/00; B32B 5/18; B32B 5/32; B32B 7/12; B32B 37/10; B32B 37/1284; C09J 11/06; C09J 133/08; C09J 175/04; B32B 2250/02; B32B 2250/22; B32B 2255/102; B32B 2255/26; B32B 2266/0278; B32B 2305/022; B32B 2307/308; B32B 2307/718; B32B 2307/748; B32B 2309/12; B32B 2333/08; B32B 2375/00; B32B 2479/00; B32B 2601/00; C09J 2433/00; C09J 2475/00

(57) ABSTRACT

A method for bonding substrates, in particular foams, comprising the steps of:
a) applying a dispersion adhesive (DK) to an area to be bonded of a first substrate (S1) by roller application;
b) contacting the area to be bonded of the first substrate (S1) with a second substrate (S2) to be bonded;
c) pressing the two substrates (S1, S2) so that a bonded composite (V′) of the first and second substrate (S1, S2) is obtained, in particular so that the bonded composite (V′) can be separated under formation of a cohesive fracture in the adhesive;
   whereby the dispersion adhesive (DK) contains an aqueous polyurethane and/or an aqueous acrylate dispersion and a plasticizer

### TECHNICAL FIELD

The invention relates to a method for bonding substrates, in particular foams, with a dispersion adhesive. Furthermore, the invention relates to a bonded composite of a first and a second substrate, in particular an upholstery core of upholstered furniture, a cushion or a mattress, whereby the composite can be separated again after complete drying under formation of a cohesive fracture in the adhesive. The invention also relates to the specific use of a plasticizer in a dispersion adhesive for adjusting the initial adhesion when bonding substrates, in particular foams, and for adjusting the separability of the substrates from one another after the composite has completely dried. The invention also relates to the specific use of a dispersion adhesive for producing an adhesive bond between two substrates which can be separated under formation of a cohesive fracture in the adhesive.

### STATE OF THE ART

Initially, adhesives containing solvents were used to bond foams due to a lack of other solutions. The disadvantage of these adhesives was that they were not environmentally friendly due to the solvents (VOC) present.

This problem was solved with water-based adhesives and the disadvantage of solvent emissions was eliminated. Polychloroprene-based dispersion adhesives (CR) have become established on the market for these applications. These are applied either as one-component or two-component adhesives by spraying. The formulations with polychloroprene dispersions show a sufficient initial adhesion so that the foam parts can be further processed without long drying times.

EP 0 624 634 A1 (Alfa Klebstoffe AG), for example, describes a spray-on dispersion based on an acrylic acid ester copolymer, a colloidal chloroprene polymer and boric acid. The spray material is applied to at least one or both of the substrate surfaces, the substrate surfaces to be bonded are placed wet on top of each other and pressed together for at least about 0.5 seconds with at least 0.1 N/cm².

Recycling and circular economy are currently a new requirement for materials, including in the furniture industry. Every year, millions of used mattresses are produced, which are mainly sent to landfill or incineration. In recent years, several initiatives and projects have emerged that recycle mattresses and return them to the manufacturing process.

In addition to recycling, in which the “raw material” is sorted and reused in another area of application, strong efforts are also underway to further develop upcycling, such as foam recovery. In this process, for example, a polyurethane foam is sorted back into the polyol and/or isocyanate from which it was produced. This polyol is then reused as a new raw material for the production of new foam.

Foreign substances are undesirable in this process and tests have shown that residues of polychloroprene-based adhesives can interfere with the process. The residues must therefore be filtered out and sent for separate recycling or disposal.

In general, experts are of the opinion that it makes little sense to separately recover and recycle the—usually low—proportion of adhesives from post-consumer waste. Instead, the approach is that the adhesive should interfere as little as possible with the recycling of the bonded materials. Tests have shown that polyurethane- and acrylate-based dispersion adhesives can be used in the recycling process without any adverse effects.

Various raw material suppliers have already developed polyurethane-based adhesives for 2K spray applications, which are also available on the market.

In this context, WO 2021/043674 A1 (Covestro), for example, describes formulations containing a mixture of an aqueous polyurethane or polyurethane-urea dispersion (with 60 to 80 wt. % polymer content), a plasticizer (20-40 wt. %) and a tackifier resin (0 to 10 wt. %). These adhesives should be particularly suitable for bonding foam substrates using the two-component spray coagulation process. In this process, the adhesive and a coagulant are fed separately into a spray gun, mixed in a spray jet and coagulated.

One disadvantage of spraying processes, however, is the so-called overspray or the proportion of adhesive that does not reach the substrate during spraying, but escapes into the environment in the form of spray mist. In addition, the adhesive cannot be applied very precisely by spraying. For example, it is not possible to use spraying methods without additional measures to coat specifically selected areas of substrates, such as the tips of nubs in nubbed foam, and leave the recesses between the nubs uncoated.

Furthermore, two-component spray coagulation processes tend to be prone to errors, as the two components must be applied simultaneously in defined and constant mixing ratios. It is possible to use adhesives based on polyurethane or polyurethane-urea dispersions, as described in WO 2021/043674 A1, as single-component adhesives without coagulants. However, the usually desired or required initial adhesion is lost, which delays the further processing of the bonded substrates.

In addition, a mattress may contain different sorts of polyurethane foams in the composite, which makes it difficult to recycle or upcycle by sort. It is therefore desirable that a foam composite made of different foams can be separated by sort before recycling/upcycling.

In general, it is ecologically advantageous if the mattress has a long service life before it has to be disposed of. Accordingly, long-lasting bonding of the mattress components is desirable. However, this property poses a problem for recycling, as the foams are difficult to separate from each other. This is particularly disadvantageous for composites made of different foams, as it makes it difficult to separate them by sort.

There is therefore still a need for improved solutions that do not have the disadvantages mentioned above, or at least to a lesser extent.

### DESCRIPTION OF THE INVENTION

The object of the invention is therefore to provide improved solutions for bonding substrates and for separating substrates after bonding, in particular foams, preferably polyurethane-based foams. In particular, the aim is to enable the simplest, safest and/or most precise bonding possible as well as a separation after bonding. Advantageously, this is done without having to make compromises in terms of processing speed during bonding and upcycling or separation of bonded polyurethane-based substrates. In particular, the solution is intended to improve the production and recycling/upcycling of upholstery cores for upholstered furniture, cushions or mattresses.

The solution to the problem is defined by the features of the independent claims. Further aspects of the invention, as well as particularly preferred embodiments, are the subject of the following description and the dependent claims.

A first aspect of the present invention relates to a method for bonding substrates, in particular foams, comprising the steps of:

A method for bonding substrates, in particular foams, comprising the steps of:
a) applying a dispersion adhesive to an area to be bonded of a first substrate by roller application;
b) contacting the area to be bonded of the first substrate with a second substrate to be bonded;
c) pressing the two substrates so that a bonded composite of the first and second substrate is obtained, in particular so that the bonded composite can be separated under formation of a cohesive fracture in the adhesive;
whereby the dispersion adhesive contains an aqueous polyurethane and/or an aqueous acrylate dispersion and a plasticizer.

In the event of a cohesive fracture in the adhesive, the bond in the adhesive will break. All substrate surfaces are still covered with adhesive or adhesive residue after the breakage. In the present case, a cohesive fracture occurs due to the mechanical separation of the substrates from each other, whereby the separation is carried out in particular by hand. The substrate composite is separated back into the individual substrates. The fracture only occurs in the area of the adhesive, which means that the surfaces of the separated substrate parts are completely covered with adhesive. The substrate parts and the adhesive residue adhering to them can be safely fed into the recycling or upcycling process.

The method according to the invention also allows the adhesive to be applied evenly without overspray caused by spraying. In addition, the adhesive can be applied precisely where it is needed. This also applies to specially shaped or structured substrates, such as nubbed foam or pyramid foam. Different combinations of foam qualities can also be bonded without any problems.

Furthermore, a good initial adhesion can be achieved without an additional second component, which in turn enables rapid further processing of the adhesive bond. The term “initial adhesion” refers to the holding force of an adhesive that it builds up immediately after bonding to the surface to be bonded. The initial adhesion is the initial adhesive force of a bond before the final load-bearing capacity of the bonded area, i. e. the final adhesive force, is reached.

Furthermore, the dispersion adhesive used according to the invention can be formulated as a single-component composition that is stable for several months at temperatures up to 30° C. without any special measures. This further simplifies handling and reduces the risk of faulty manipulation.

The dispersion adhesive used according to the invention is thus present in particular as a single-component dispersion adhesive. In particular, the dispersion adhesive does not have a second, coagulating component.

In the method according to the invention for bonding substrates, apart from the dispersion adhesive, which is preferably present as a single-component dispersion adhesive, in particular no other component, especially no coagulating component, is applied to the area to be bonded of the first and/or second substrate. In other words, this means that before contacting the area to be bonded of the first substrate with a second substrate to be bonded or before step b), preferably only the dispersion adhesive is applied and is applied exclusively to the area to be bonded of the first substrate.

The method therefore greatly simplifies bonding without compromising on processing speed. This comes as a surprise. Until now, it has been assumed that in order to achieve good initial adhesion, a coagulating second component has to be added to the dispersion adhesives shortly before and/or during the application of the dispersion adhesive. The fact that the initial adhesion can be improved, let alone increased to the extent observed, by the addition of a plasticizer was therefore not to be expected by the skilled person. Without being bound by theory, it is assumed that the plasticizer diffuses into the adhesive particles and that this improves the initial adhesion.

The method according to the invention is also particularly advantageous with regard to the upcycling of adhesive composites made of different substrate materials, since the substrates in the substrate composite can be easily separated from the composite again, in particular by hand, under formation of a cohesive fracture in the adhesive, thus simplifying single-sort recycling. The fact that the separability of the substrates can be adjusted by the plasticizer also comes as a surprise to the skilled person.

A further advantage of the method according to the invention is therefore that substrates of the bonded composites can be fed to the upcycling process separately from each other and without negative effects due to the polyurethane- and/or acrylate-based dispersion adhesives used.

The method according to the invention thus offers great advantages in particular for the manufacture and recycling/upcycling of upholstery cores of upholstered furniture, cushions or mattresses, especially for models which consist of different substrate materials and/or have contours such as nubs or the like.

The dispersions referred to as “polyurethane dispersions” in the context of the present invention contain particles of polyurethane polymers as the disperse phase in an aqueous liquid or water as continuous phase.

The polyurethane polymers of the polyurethane dispersions are based on polymers which are obtainable by reacting polyols, in particular diols, with polyisocyanates, in particular diisocyanates, and optionally with mono- and/or diamines. Suitable polyurethane polymers are obtainable, for example, by reacting at least one polyol with at least one polyisocyanate. This reaction can be carried out by reacting the polyol and the polyisocyanate using conventional methods, for example at temperatures of 50-100° C., optionally with the use of suitable catalysts, whereby the polyisocyanate is dosed in such a way that its isocyanate groups are present in stoichiometric excess in relation to the hydroxyl groups of the polyol. Such processes are known to the person skilled in the art.

The term polyurethane polymer covers all polymers that are produced using the so-called polyisocyanate polyaddition process. Examples of polyurethane polymers are polyether polyurethanes, polyester polyurethanes or polyether polyureas.

A “polyether polyurethane” is a polymer that has ether groups as repeating units and additionally contains urethane groups. A “polyester polyurethane” is correspondingly a polymer which has ester groups as repeating units and additionally contains urethane groups.

The polyols are, for example, commercially available polyols, which are preferably liquid at room temperature. For example, the polyols have an average molecular weight Mn in the range of at least 400 g/mol, in particular 400 to 30'000 g/mol, especially preferred 1'000 to 10'000 g/mol, very particularly 2'000 to 5'000 g/mol.

In particular, the polyols are polyester polyols and/or polyether polyols, especially difunctional polyester polyols and/or difunctional polyether polyols.

Polyester polyols can be produced, for example, by polycondensation of dicarboxylic acids with polyols.

Possible dicarboxylic acids for this are, for example, adipic acid, succinic acid, methyl succinic acid, glutaric acid, sebacic acid, maleic acid and/or dodecanedioic acid.

Preferred polyol components for the polyester polyols are ethanediol-1,2, butanediol-1,4 and hexanediol-1,6, in particular butanediol-1,4 and hexanediol-1,6 especially preferred butanediol-1,4.

Polyester polyols can, for example, be based on succinic acid, methyl succinic acid, glutaric acid, adipic acid and/or maleic acid in combination with 1,3-propanediol, 1,4-butanediol and/or 1,6-hexanediol.

Preferred polyol components for the polyether polyols are, for example, homopolymers, copolymers and/or graft polymers of ethylene oxide and/or propylene oxide.

The polyisocyanates are selected in particular from aliphatic or aromatic diisocyanates.

For example, the polyisocyanates are 4,4′-diphenyl methane diisocyanate, optionally with proportions of 2,4′- and/or 2,2′-diphenyl methane diisocyanate (MDI), 2,4-toluylene diisocyanate or mixtures thereof with 2,6-toluylene diisocyanate (TDI), 1,4-phenylene diisocyanate (PDI), naphthalene-1,5-diisocyanate (NDI), 1,6-hexane diisocyanate (HDI), 2,2(4),4-trimethyl-1,6-hexamethylene diisocyanate (TMDI), cyclohexane 1,3- or -1,4-diisocyanate, 1-isocyanato-3,3,5-trimethyl-5-isocyanatomethylcyclohexane (isophorone diisocyanate or IPDI), perhydro-2,4′- or -4,4′-diphenylmethane diisocyanate (HMDI), 1,3- or 1,4-bis(isocyanato-methyl)cyclohexane, m- or p-xylylene diisocyanate (XDI), m-tetramethylxylylene diisocyanate (TMXDI), or mixtures thereof.

In particular, the polyurethane polymers are anionic polyurethane polymers. These can be obtained, for example, if a chain extender with an anionic group, in particular a sulphonate, carboxy and/or carboxylate group, is additionally present during the reaction of the polyols with the polyisocyanates.

In particular, the polymer contained in the polyurethane dispersion is semi-crystalline or crystalline. A polymer is described as semi-crystalline or crystalline if it has a melting peak in the differential scanning calorimetry (DSC) measurement according to DIN 65467:1999 at a heating rate of 20K/min, which corresponds to a melting enthalpy >5 J/g, preferably >10 J/g, particularly preferred >20 J/g and especially preferred >40 J/g.

Based on the total weight of the aqueous polyurethane dispersion, the same has preferably a solids content of 30-60 wt. %, in particular 35-55 wt. %, especially 40-50 wt. %. The solids content corresponds in particular to the non-volatile content measured according to DIN EN ISO 3251:2019 (1 g/1 h/125° C.).

Preferably, the aqueous polyurethane dispersion is an anionic aqueous polyurethane dispersion.

In particular, the aqueous polyurethane dispersion has a pH value in the range of 6-9, whereby the pH value is preferably measured according to DIN ISO 976:2016.

In particular, the aqueous polyurethane dispersion at 23° C. has a viscosity of <1'500 mPa·s, in particular <1'000 mPa·s, for example 30-950 mPa·s. The viscosity is preferably measured according to standard M092-ISO 2555:2018 with spindle L2 at 30 revolutions per minute.

It is also advantageous if the aqueous polyurethane dispersion has a minimum film-forming temperature of >1° C., in particular >2° C., especially >4° C., for example 5° C. or more. The minimum film-forming temperature is preferably measured according to DIN ISO 2115:2001.

Especially preferred, the aqueous polyurethane dispersion has the following features in combination:
the aqueous polyurethane dispersion is an anionic aqueous polyurethane dispersion;
the pH value is in the range of 6-9;
at 23° C., the aqueous polyurethane dispersion has a viscosity of <1'500 mPa·s, in particular <1'000 mPa·s, for example 30-950 mPa·s, whereby the viscosity is measured in accordance to standard M092-ISO 2555:2018 with spindle L2 at 30 revolutions per minute
a minimum film-forming temperature of the aqueous polyurethane dispersion is >1° C., in particular >2° C., especially >4° C., for example at 5° C. or more.

The dispersions referred to as “acrylate dispersions” in the context of the present invention contain particles of acrylate polymers, in particular acrylate copolymers, as disperse phase in an aqueous liquid or water as continuous phase.

In particular, the acrylate polymers are acrylate copolymers.

The monomers contained in the polyacrylates consist, for example, but not exclusively, of alkyl acrylates and/or methacrylates. Furthermore, the monomers can also be comonomers that are based neither on acrylic acids nor on methacrylic acids, for example styrene and/or acrylonitrile.

The aqueous acrylate dispersion has in particular a pH value in the range of 2-9, preferably 2-7, whereby the pH value is preferably measured according to DIN ISO 976:2016.

The acrylate polymer contained in the aqueous acrylate dispersion preferably has a glass transition temperature T_{g} of 0 to −50° C., in particular −5 to −45° C. With such acrylate dispersions, the adhesive can be specifically adapted to special applications.

Glass transition temperatures, melting temperatures and melting enthalpies can be determined in a known manner using differential scanning calorimetry (DSC).

Based on the total weight of the aqueous acrylate dispersion, the same has in particular a solids content of 30-70 wt. %, particularly 40-70 wt. %, especially 50-70 wt. %. The solids content corresponds in particular to the non-volatile content measured according to DIN EN ISO 3251:2019 (1 g/1 h/125° C.).

Especially preferred, the aqueous acrylate dispersion has the following features in combination:
the aqueous acrylate dispersion comprises an acrylate polymer, in particular an acrylate copolymer;
the pH value is in the range of 2-9, in particular 2-7.

Preferably, the ratio between the aqueous polyurethane dispersion and the aqueous acrylate dispersion is 1:9-9:1, in particular 1:2-2:1, for example 1:1.

The viscosity of the dispersion adhesive used, containing the aqueous polyurethane and/or acrylate dispersion and the plasticizer, is preferably at least 1'000 mPa·s, in particular at least 1'500 mPa·s, for example at least 2'000 mPa·s. An upper limit of the viscosity of the dispersion adhesive is, for example, 15'000 mPa·s, in particular 10'000 mPa·s, for example 5'000 mPa·s. The addition of the plasticizer typically increases the viscosity of the aqueous polyurethane and/or acrylate dispersion, so that, for example, with the aqueous polyurethane and/or acrylate dispersions as described above the dispersion adhesives with such viscosities can be obtained. If necessary, additional viscosity-modifying agents, e.g. thickeners, can also be added.

Based on the total weight of the dispersion adhesive, a proportion of the aqueous dispersion(s) in the adhesive, in particular of the aqueous polyurethane dispersion, the aqueous acrylate dispersion or the aqueous polyurethane dispersion and the aqueous acrylate dispersion together, is in total 50-95 wt. %, preferably 60-95 wt. %, in particular 60-80 wt. %. This achieves optimal bonding effects.

In a preferred embodiment, the adhesive material is as similar as possible to the substrate material, in particular the adhesive material and the substrate material are identical. For example, in the case of mattresses with polyurethane foams, a polyurethane-based adhesive is used.

“Plasticizers”, as contained in the dispersion adhesive in the present invention, are chemical substances that are added to polymers to make them softer, more flexible, more elastic and/or more smooth for further processing.

The plasticizer is selected in particular from citrates, benzoates, adipates, phthalates, sebacates, esters, dibasic esters, polyethylene glycol esters, hexanoates and/or epoxidized soybean oils. Dibasic esters are in particular dialkyl esters of the dicarboxylic acids glutaric acid, succinic acid and adipic acid.

The plasticizer is preferably selected from one or more of the following substances:
citrates, in particular acetyl tributyl citrate and/or tributyl-0-acetyl citrate;
benzoates, in particular esters of benzoic acid, preferably butyl benzoate, isodecyl benzoate, oxidipropyl dibenzoate, dipropyleneglycol dibenzoate, diethyleneglycol dibenzoate and/or combinations of dipropyleneglycol dibenzoate and diethyleneglycol dibenzoate;
adipates, in particular benzyl (2-ethylhexyl) adipate (BOA), dioctyl adipate (DOA), dibutyl adipate and/or di-n-butyl adipate (DBA);
phthalates, in particular benzyl butyl phthalate (BBP), diisononyl phthalate (DINP), bis(2-ethylhexyl) terephthalate (DOTP) and/or dibutyl terephthalate;
sebacates, in particular dibutyl sebacate and/or 2-ethylhexyl sebacate
esters in the form of dibasic isobutyl ester, polyethylene glycol ester, polyethylene glycol oleate, polyethylene glycol sebacate and/or tetraethylene glycol ester;
hexanoates, in particular 2,2′-ethylenedioxydiethylbis(2-ethylhexanoate)

In particular, the plasticizer is a benzoate and/or adipate.

A proportion of plasticizer, based on the total weight of the dispersion adhesive, is preferably 5-50 wt. %, in particular 20-40 wt. %, especially 32-38 wt. %.

Preferably, a proportion of plasticizer is adjusted such that an initial adhesion is present after step b) and before step c) and/or a proportion of plasticizer is adjusted such that a bond is produced which can be separated under formation of a cohesive fracture in the adhesive. Preferably, the amount of plasticizer is adjusted in such a way that both an initial adhesion is present and a bond is produced which can be separated under formation of a cohesive fracture in the adhesive. This is possible in particular with the above-mentioned proportions.

In particular, the dispersion adhesive contains glycerine in addition to a plasticizer. Glycerine can be used to adjust or reduce the cohesive adhesion in the adhesive, which is particularly advantageous for acrylate dispersions. Without being bound by theory, it is assumed that glycerine diffuses less into the polymer particles and thus facilitates a cohesive fracture in the adhesive after the substrate has dried completely.

A proportion of glycerine, based on the total weight of the dispersion adhesive, is preferably 5-25 wt. %, in particular 10-15 wt. %.

Furthermore, the dispersion adhesive may additionally contain one or more additives, in particular one or more additives from the group consisting of: Thickeners, emulsifiers, defoamers, wetting agents, biocides and extenders. A proportion of additives is, for example, 0.01-10 wt. %, in particular 0.1-5 wt. %, based on the total weight of the dispersion adhesive.

The dispersion adhesives used according to the invention are preferably prepared by mixing the aqueous polyurethane and/or acrylate dispersion with the plasticizer and possibly with other components, for example glycerine. This can be done in any order. Preferably, a polyurethane and/or acrylate dispersion is introduced and then the plasticizer and optionally other components, for example glycerine, are added while stirring.

The amount of plasticizer is adjusted so that there is an initial adhesion after step b) and before step c).

Aqueous polyurethane dispersions as well as aqueous acrylate dispersions are also commercially available from various suppliers. The following polyurethane dispersions can be used, for example: Dispercoll® U 53, Dispercoll® U 54, Dispercoll® U 84 and Dispercoll® U XP 2643 (available from Covestro Deutschland GmbH). Acrylic dispersions that can be used are for example Carbobond™ 1995 (available from Lubrizol USA).

In the present case, a substrate is understood to be a solid material. Preferably, the first substrate and/or the second substrate is a foam. Foams are generally artificially produced substances with a cellular structure. Preferably, the first and/or the second substrate is an open-cell or mixed-cell foam.

The density of the first foam and/or the second foam is, for example, 10-60 kg/m³, in particular 20-50 kg/m³.

In a preferred embodiment of the invention, the first and/or the second substrate is made of a polyurethane foam and/or a rubber. Rubber is, for example, natural rubber (NR). Foams made of polyurethane are, for example, polyether polyurethane foams or polyester polyurethane foams.

In a particularly preferred embodiment of the invention, the first and/or the second substrate is a polyurethane foam.

The first substrate and/or the second substrate has in the area to be bonded in particular a structured surface with recesses and elevations. The dispersion adhesive is preferably applied exclusively in the areas of the elevations.

In particular, the first substrate and/or the second substrate is a contour foam, which preferably has nubs and/or pyramids, and the dispersion adhesive is preferably only applied to the tips of the nubs and/or pyramids in the area to be bonded.

In a preferred embodiment, the substrates are present as monomaterials. This means that a substrate is a single type of material, for example a specific type of polyurethane foam. This simplifies the recycling of the substrate, in particular the foam.

In the case of “roller application”, as it is carried out in the present bonding method, the dispersion adhesive is applied to the first substrate using a roller, which is referred to as an application roller. Application rollers usually have a surface made of stainless steel, in particular chromium-nickel steel, especially steel of type V2A, V4A and/or 1.4301, etc. The dispersion adhesive is applied to the application roller and transferred to the first substrate from the application roller, which is brought into contact with the first substrate.

In particular, the dispersion adhesive is applied during roller application in step a) in the unidirectional method, so that the direction of rotation of the application roller in the contact area with the first substrate has the same direction as the first substrate moving past the application roller.

However, application can also be carried out using the counter-rotation method.

In principle, the dispersion adhesive can be applied to the application roller using different methods during roller application.

A first possibility is to apply the dispersion adhesive to the rotating application roller via a dispenser in step a) during roller application, and in particular to distribute it evenly on the application roller using a squeegee. The first substrate is then brought into contact with the application roller to apply the dispersion adhesive in the area to be bonded, so that the dispersion adhesive is applied to the area to be bonded by the application roller. The amount of dispersion adhesive per unit area on the application roller and therefore the amount applied to the substrate can be controlled via the distance between the squeegee and the application roller.

A second and particularly preferred option is in step a) during roller application to apply the dispersion adhesive to the rotating application roller using a rotating dosing roller and to bring the first substrate in the area to be bonded into contact with the application roller for applying the dispersion adhesive, so that the dispersion adhesive is applied to the area to be bonded by the application roller.

In particular, the dosing roller is set exactly parallel to the application roller and has no direct contact with the substrate.

In the second option, the dispersion adhesive is preferably present between the application roller and the dosing roller in the so-called roller stock. The dispersion adhesive is distributed evenly through the gap between the two rollers and the distance between the dosing roller and the application roller can be used to control the amount of dispersion adhesive per unit area on the application roller and thus the application amount on the substrate. The method with the dosing and application roller has the advantage that fewer shear forces act on the dispersion adhesive.

The application roller and the dosing roller preferably run unidirectional in the area of the gap between the two rollers. This ensures a particularly even application of adhesive.

Preferably, the dispersion adhesive is applied to the first substrate in an amount of 10-100 g/m², in particular 20-80 g/m², preferably 40-60 g/m². Depending on the substrate, smaller amounts may result in an insufficient adhesive effect. Larger amounts will take longer to dry and the initial adhesion will be worse.

According to a preferred embodiment, no dispersion adhesive or other adhesive is applied to the second substrate to be bonded. However, this may still be the case in special cases.

In a preferred embodiment, the two substrates are pressed against each other after step b) and before step c), in particular by hand, preferably so that a starting initial adhesion is created before the pressing in step c). This ensures that the substrates no longer slip before they are pressed in step c). The starting initial adhesion therefore enables a clean bonding of the foam boards. The initial adhesion can then be further increased in step c).

In step c), the two substrates are preferably pressed for a total time of 1-60 seconds, in particular 2-30 seconds, preferably 3-10 seconds.

Especially preferred, the two substrates are pressed several times in step c), in particular 2-10 times, preferably 3-5 times. This means that after a first pressing, in which a pressing pressure is applied, the pressing pressure on the substrates is reduced or completely removed and then a new pressing pressure is applied to the two substrates. If necessary, this is repeated several times as indicated. This ensures an optimal bonding effect.

The pressing pressure during pressing is preferably 10'000-150'000 N/m², preferably 10'000-80'000 N/m², in particular 10'000-30'000 N/m².

A proportion of plasticizer and/or the pressing force applied during pressing is adjusted for the method in such a way that a composite is produced which can be separated under formation of a cohesive fracture in the adhesive. This can be achieved using the amounts of plasticizer described above and/or the pressing pressures mentioned. This allows the substrates to be separated from the composite again. The cohesive fracture in the adhesive occurs without foam breakage, i. e. the adhesive residues completely cover the substrate surfaces of the separated substrate parts after separation.

The adhesion of the bonded composite obtained immediately after pressing is in particular >0.1 N/cm², for example >1 N/cm², especially >2.5 N/cm² or >4.5 N/cm². This applies particularly when bonding substrates made of foams, especially polyurethane foams.

After step b) and before step c) in particular, there is a starting initial adhesion which is lower than the initial adhesion after step c).

In particular, the method is used to produce a bonded composite in the form of an upholstered core of upholstered furniture, a cushion or a mattress.

However, any other bonded composites can also be produced. The upholstery core preferably consists of foam, in particular a polyurethane foam.

A further aspect of the present invention relates to a bonded composite of a first and a second substrate, in particular an upholstery core of an upholstered furniture, a cushion or a mattress, whereby the composite is obtainable or obtained by a method as described above.

The substrates present in the bonded composite can be separated from each other after the composite has dried completely, under formation of a cohesive fracture in the adhesive, in particular without foam breakage. Separation is achieved by pulling the bonded substrates apart in the opposite direction, in particular by hand, whereby the adhesive forms a cohesive fracture under the force applied, in particular without foam breakage. This means that after separation, the separated substrates each have adhesive residues on the previously bonded surfaces, whereby the adhesive completely covers the surfaces.

A further aspect of the invention relates to the use of a plasticizer in a dispersion adhesive based on a polyurethane and/or acrylate dispersion for adjusting the initial adhesion when bonding substrates, in particular foams, with the dispersion adhesive and/or for adjusting the separability of the substrates from each other after the composite has completely dried.

In a further aspect, the invention also relates to the use of a dispersion adhesive as described above for producing an adhesive bond between two substrates, in particular foams, which can be separated under formation of a cohesive fracture in the adhesive.

The dispersion adhesive, the polyurethane and/or acrylate dispersion, and the application method are preferably defined as described above for the uses mentioned.

Further advantageous embodiments and combinations of features of the invention result from the following detailed description and the entirety of the patent claims.

### BRIEF DESCRIPTION OF THE DRAWINGS

The drawings used to illustrate the embodiment show:

FIG. 1a-1d a schematic illustration of a method according to the invention for bonding substrates with a dispersion adhesive based on an aqueous polyurethane and/or an aqueous acrylate dispersion, a plasticizer and optionally with glycerine;

FIG. 2 a nubbed foam from the side coated at the tips of the nubs with dispersion adhesive using the method shown in FIGS. 1a-1d;

FIGS. 3a-3c a schematic illustration of a method according to the invention for separating substrates by a cohesive fracture in the adhesive.

In principle, identical parts are marked with the same reference symbols in the figures.

### WAYS TO CARRY OUT THE INVENTION

### Method for Bonding Substrates

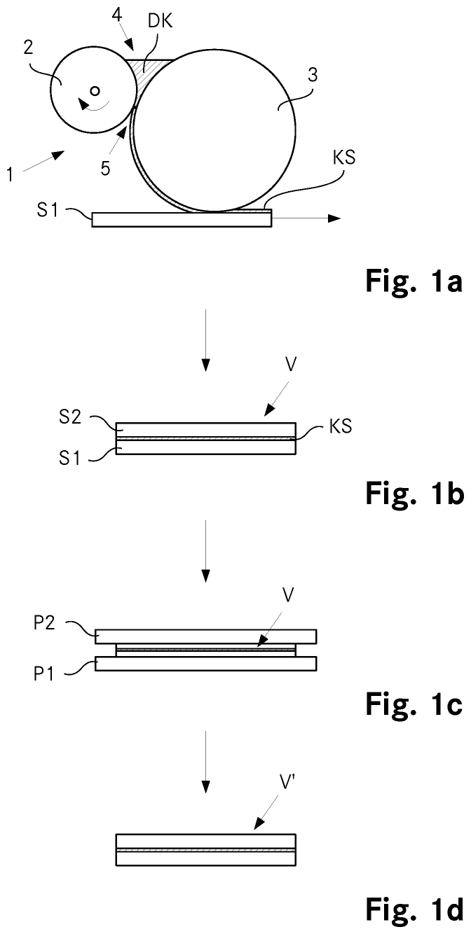

FIGS. 1a-1d show a schematic illustration of a method according to the invention for bonding substrates with a dispersion adhesive DK based on an aqueous polyurethane and/or an aqueous acrylate dispersion, a plasticizer and optionally with glycerine.

In FIG. 1a, a dispersion adhesive DK is applied to the upper side of a first substrate S1, e.g. a foam substrate, by roller application. The dispersion adhesive consists, for example, of an aqueous polyurethane and/or an aqueous acrylate dispersion, a plasticizer and optionally glycerine. The dispersion adhesive DK is applied using a roller application device 1, which has an application roller 3 and a counter-rotating dosing roller 2 arranged parallel to it. The dispersion adhesive DK is present in the roller stock 4 and is transferred to the application roller 3 via the dosing roller 2. By adjusting the gap width 5 between the dosing roller 2 and application roller 3, the amount of dispersion adhesive DK that is transferred to the application roller 3 and from this to the substrate S1 moving along the application roller 3 in a unidirectional method, can be controlled.

During the application of the dispersion adhesive DK in FIG. 1a, the substrate S1 moves to the right by a not shown conveyor device (e.g. a conveyor belt). As a result, a defined adhesive layer KS of dispersion adhesive DK is applied to the upper side of the substrate S1. The upper side of the substrate S1 thus forms the area to be bonded of the first substrate S1.

Subsequently, a second substrate S2, e.g. another foam substrate, is placed on the surface of the first substrate S1 coated with the adhesive layer and pressed on, in particular by hand, so that a composite V of substrate S1, adhesive layer KS and substrate S2 is formed. The composite V is shown in FIG. 1b. In this state, there is an initial adhesion between the substrates S1 and S2. This means that the substrates S1 and S2 can no longer slip due to the initial adhesion before pressing.

In the next step, which is shown in FIG. 1c, the composite V is pressed between two press plates P1, P2 with a defined pressing force.

This leads to a bond V′, which is shown in FIG. 1d and has an initial adhesion. After the adhesive layer KS has cured, the final adhesion between the two substrates S1 and S2 is achieved.

### Contour Foam with Nubs

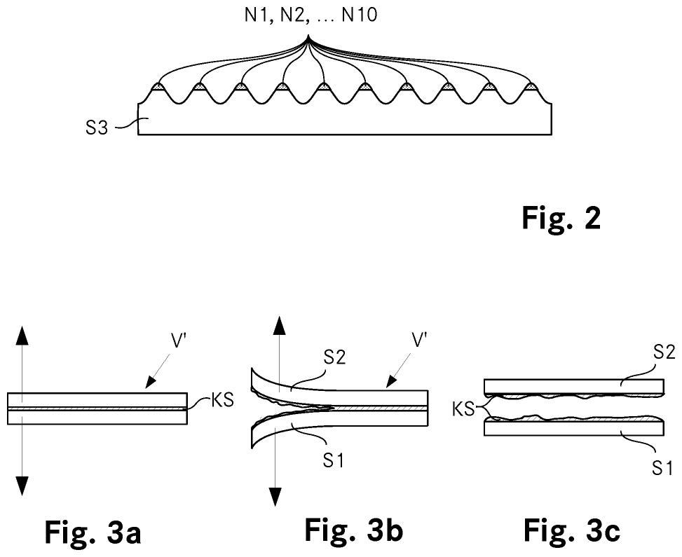

FIG. 2 shows another substrate S3 in the form of a contour foam with nubs from the side. The same was coated with dispersion adhesive DK using the roller application device 1 shown in FIG. 1a only on the tips of the nubs N1, N2 . . . N10, while the recesses in between have no adhesive coating.

The contour foam coated in this way can then be bonded to another substrate as described above.

### Method for Separating Substrates

The cured composite V′ can be separated again into the substrates S1 and S2, as shown in FIGS. 3a-3c.

For this purpose, the substrates S1 and S2 are moved away from each other in opposite directions, in particular by hand (FIG. 3a), whereby a cohesive fracture occurs in the adhesive (FIG. 3b). The breakage in the adhesive occurs in such a way that the adhesive residues adhere to the surfaces of the substrates S1 and S2. The adhesive residues cover the substrate surfaces S1 and S2 in their entirety. After the separation process, the substrates S1 and S2 and the adhesive residues adhering to them are separated from each other and the bond V′ is completely released (FIG. 3c).

### Tests

For test purposes, various foam substrates were bonded together using the method described above.

The substrates used were commercially available foam boards (500 mm×500 mm×30 mm) made of polyurethane foam (PU) and visco foam (Visco), such as those used in the manufacture of mattress cores, for example.

To press the adhesive composites, they were pressed together three times in succession for a period of 2 seconds each at a pressing force of 60'000 N/m².

Three sets of tests were carried out, whereby the dispersion adhesives used were composed as follows (all components were mixed together beforehand):
1) 80 wt. % of an aqueous polyurethane dispersion in the form of Dispercoll® U 84 and 20 wt. % of a plasticizer in the form of oxidipropyl dibenzoate;
2) 80 wt. % of an aqueous acrylate dispersion in the form of Carbobond™ 1995 and 20 wt. % of a plasticizer in the form of oxidipropyl dibenzoate;
3) 80 wt. % of an aqueous acrylate dispersion in the form of Carbobond™ 1995, 10 wt. % of a plasticizer in the form of oxidipropyl dibenzoate, 10 wt. % of glycerine.

The dispersion adhesives produced in this way were stable in storage for several months.

For all three adhesives 1), 2) and 3), the tests show that the adhesive composites have a starting initial adhesion before pressing, which enables pressing without the substrates slipping. The starting initial adhesion is lower than the initial adhesion achieved after pressing.

The use of the glycerine-containing adhesive 3) also led to a reduced final adhesion of the bonded composite compared to adhesives 1) and 2) (without glycerine).

The initial adhesion can also be increased by passing the first substrate through a heat tunnel (approx. 80° C.). Through the increased temperature or also through a flash-off, a higher initial adhesion can be achieved.

Optimal application amounts are 40 g/m²-60 g/m², which at room temperature and without flash-off lead to high initial adhesion and easily detachable adhesive bonds. As amounts of 40 g/m² give essentially the same adhesion values as 60 g/m², the lower amounts are preferable.

We claim:

1-15. (canceled)

16. A method for bonding substrates, comprising the steps of:
applying a dispersion adhesive to an area to be bonded of a first substrate by roller application;
contacting the area to be bonded of the first substrate with a second substrate to be bonded;
pressing the two substrates so that a bonded composite of the first and second substrate is obtained, so that the bonded composite can be separated with the formation of a cohesive fracture in the adhesive;
whereby the dispersion adhesive contains an aqueous polyurethane and/or an aqueous acrylate dispersion and a plasticizer.

17. The method according to claim 16, whereby the plasticizer is selected from one or more of the following substances:
citrates, in particular acetyl tributyl citrate and/or tributyl-O-acetyl citrate;
benzoates, in particular esters of benzoic acid, preferably butyl benzoate, isodecyl benzoate, oxidipropyl dibenzoate, dipropyleneglycol dibenzoate, diethyleneglycol dibenzoate and/or combinations of dipropyleneglycol dibenzoate and diethyleneglycol dibenzoate;
adipates, in particular benzyl (2-ethylhexyl) adipate (BOA), dioctyl adipate (DOA), dibutyl adipate and/or di-n-butyl adipate (DBA);
phthalates, in particular benzyl butyl phthalate (BBP), diisononyl phthalate (DINP), bis(2-ethylhexyl) terephthalate (DOTP) and/or dibutyl terephthalate;
sebacates, in particular dibutyl sebacate and/or 2-ethylhexyl sebacate
esters in the form of dibasic isobutyl ester, polyethylene glycol ester, polyethylene glycol oleate, polyethylene glycol sebacate and/or tetraethylene glycol ester;
hexanoates, in particular 2,2′-ethylenedioxydiethylbis(2-ethylhexanoate).

18. The method according to claim 16, whereby the dispersion adhesive contains glycerine in addition and whereby a proportion of glycerine, based on the total weight of the dispersion adhesive, is 5-25 wt. %.

19. The method according to claim 16, whereby a proportion of plasticizer and/or a pressing force applied during pressing is adjusted in such a way that a composite is produced which can be separated under formation of a cohesive fracture in the adhesive.

20. The method according to claim 16, whereby a proportion of plasticizer, based on the total weight of the dispersion adhesive, is 5-50 wt. %.

21. The method according to claim 16, whereby the aqueous polyurethane dispersion
is an anionic aqueous polyurethane dispersion;
has a pH value in the range of 6-9;
at 23° C. has a viscosity of <1'500 mPa·s, whereby the viscosity is measured according to standard M092-ISO 2555:2018 with spindle L2 at 30 revolutions per minute;
-has a minimum film-forming temperature of >1° C.;
and/or whereby the aqueous acrylate dispersion
comprises an acrylate polymer;
has a pH value in the range of 2-9.

22. The method according to claim 16, whereby an acrylate polymer contained in the aqueous acrylate dispersion has a glass transition temperature T_{g} of 0 to −50° C.

23. The method according to claim 16, whereby based on the total weight of the dispersion adhesive, a proportion of the aqueous dispersion(s), the aqueous acrylate dispersion or the aqueous polyurethane dispersion and the aqueous acrylate dispersion together, is in total 50-95 wt. %.

24. The method according to claim 16, whereby the ratio between the aqueous polyurethane dispersion and the aqueous acrylate dispersion is 1:9-9:1, in particular 1:2-2:1, for example 1:1.

25. The method according to claim 16, whereby the first substrate and/or the second substrate is a foam.

26. The method according to claim 16, whereby the dispersion adhesive is applied to the first substrate in an amount of 10-100 g/m².

27. The method according to claim 16, whereby the pressing pressure during pressing is 10'000-150'000 N/m².

28. The method according to claim 16, whereby in step a) during roller application the dispersion adhesive is applied between a dosing roller and a rotating application roller using the rotating dosing roller and the first substrate in the area to be bonded is brought into contact with the application roller for applying the dispersion adhesive, so that the dispersion adhesive is applied to the area to be bonded by the application roller.

29. A bonded composite of a first substrate and a second substrate, whereby the bonded composite is obtained by applying a dispersion adhesive to an area to be bonded of the first substrate by roller application;
contacting the area to be bonded of the first substrate with the second substrate to be bonded;
pressing the two substrates so that a bonded composite of the first and second substrate is obtained, so that the bonded composite can be separated with the formation of a cohesive fracture in the adhesive; whereby the dispersion adhesive contains an aqueous polyurethane and/or an aqueous acrylate dispersion and a plasticizer.

30. Use of a plasticizer in a dispersion adhesive based on a polyurethane and/or an acrylate dispersion for adjusting an initial adhesion when bonding substrates, with the dispersion adhesive and/or for adjusting the separability of the substrates from each other after the composite has completely dried.
